(19) United States
(12) Patent Application Publication
(10) Pub. No.: US 2014/0184618 A1
(43) Pub. Date: Jul. 3, 2014

(54) GENERATING CANONICAL IMAGING FUNCTIONS

(71) Applicant: Scott A. Krig, Folsom, CA (US)

(72) Inventor: Scott A. Krig, Folsom, CA (US)

(21) Appl. No.: 13/730,474

(22) Filed: Dec. 28, 2012

(51) Int. Cl. G06T 1/20

(52) U.S. Cl. CPC G06T 1/20
USPC 345/506

(57) ABSTRACT

A method for coalescing monolithic imaging functions includes providing a canonical imaging function template. A set of canonical imaging functions is formed from the monolithic imaging functions. The set of canonical imaging functions adhere to the canonical imaging function template. One or more of the canonical imaging functions of the set of canonical imaging functions are coalesced into a coalesced imaging function.

### TECHNICAL FIELD

The present techniques are generally directed to image processing. More particularly, the present techniques relate to an apparatus for optimizing image processing pipelines using canonical imaging functions.

### BACKGROUND ART

Image processing pipelines typically consist of many data-parallel stages that benefit from parallel execution across image pixels, but the stages are often memory bandwidth limited, i.e., the stages may be inefficient in terms of memory access (load and store) operations. Some modest gains in pipeline performance have been achieved by optimizing the inner loops of the pipelines to, inter alia, eliminate redundant memory copies and reduce memory traffic. However, such optimizations are manual processes requiring the skill of a programmer having knowledge of the target computing or processing architecture as well as the particular imaging algorithms to be processed. Further, such optimizations are generally not portable across computing or processing architectures.

### BRIEF DESCRIPTION OF THE DRAWINGS

The following detailed description may be better understood by referencing the accompanying drawings, which contain specific examples of numerous objects and features of the disclosed subject matter.

FIG. 1A is a block diagram of a monolithic function, in accordance with embodiments;

FIG. 1B is a block diagram of a canonical imaging function template or class, in accordance with embodiments;

FIG. 2 is a block diagram of a coalesced canonical imaging function, in accordance with embodiments;

FIG. 3 is a process flow diagram illustrating a method for coalescing canonical imaging functions, in accordance with embodiments;

FIG. 4 is a block diagram of a computing device that may be used in accordance with embodiments; and

FIG. 5 is a block diagram of a tangible, non-transitory computer-readable media that stores instructions for the method of coalescing canonical imaging functions, in accordance with embodiments.

### DESCRIPTION OF THE EMBODIMENTS

As discussed above, the manual optimization of image processing pipelines is time consuming, and such optimizations are not portable across computing or processing architectures. As a result, optimization of image processing pipelines can be cost prohibitive.

Embodiments of the present techniques provide for a canonical imaging function template or class. A set of canonical imaging functions is formed from monolithic imaging functions. The canonical imaging functions adhere to a canonical imaging function template. The canonical imaging functions are coalesced into a coalesced imaging function.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM), random access memory (RAM), magnetic disk storage media, optical storage media, flash memory devices, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

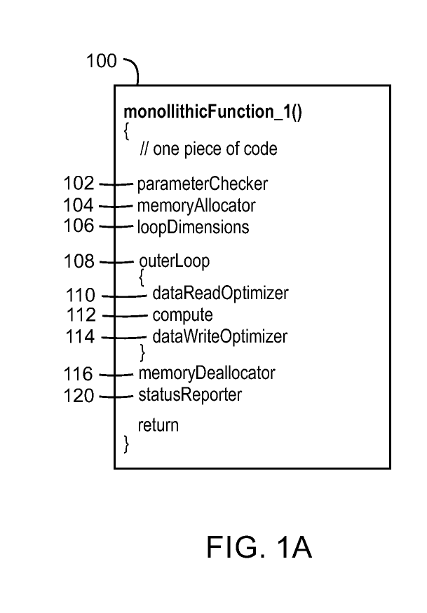

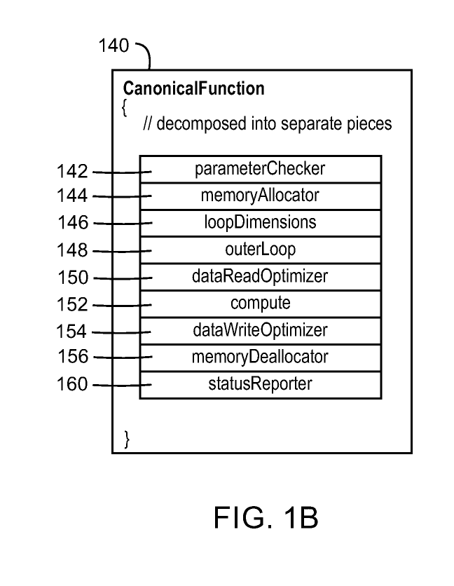

FIG. 1A illustrates a monolithic imaging function 100. Function 100 is constructed as a unitary block or single piece of computer-readable code that, when executed, performs the plurality of exemplary routines 102-120. More particularly, imaging function 100 includes a parameter checker 102, a memory allocator 104, a loop dimensions 106, and an outer loop 108. The outer loop 108 includes a data read optimizer 110, a compute 112 and a data write optimizer 114. The imaging function 100 further includes a memory de-allocator 116 and a status reporter 120.

The parameter checker 102, when executed, reads or otherwise receives input data required by the imaging function 100, and the memory allocator 104 allocates memory that may be required to store the data required or created by the imaging function 100. The input data to the imaging function 100 may include image data read from an input image data buffer or other computer-readable memory. The loop dimensions 106 can indicate the parameters or dimensions of the outer loop 108. In embodiments, the loop dimensions 106 may indicate the number of pixels or regions of an image to be processed by the outer loop 108. The outer loop 108 manages execution of the routines within outer loop 108, such as, for example, by incrementing or otherwise maintaining counters and other outer loop control data. In embodiments, outer loop 108 keeps track of what portion of an image (e.g., which pixel or region) is being processed or is next to be processed within outer loop 108.

Within the outer loop 108, the data read optimizer 110 performs the caching and look-ahead buffering of image data to be read and operated upon or processed by outer loop 108 of imaging function 100. The compute 112 routine performs one or more computations on the image data. In embodiments, the compute 112 routine may filter, convolute or otherwise modify or enhance the image data. The data write optimizer 114 optimizes the process of writing data resulting from operations the within the outer loop 108, including the compute 112.

When the outer loop 108 is complete, the memory de-allocator 116, when executed, frees or otherwise clears the memory previously allocated to the imaging function 100 to be available for use by other functions or for other purposes. The status reporter 120 provides status or other information related to the execution of the imaging function 100.

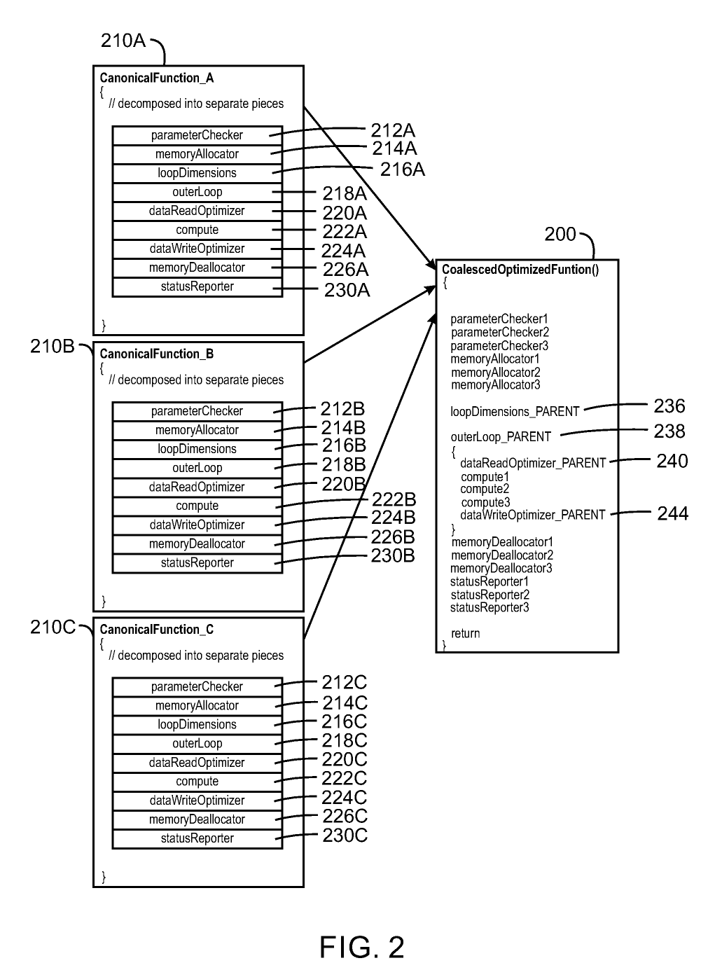

FIG. 1B illustrates an exemplary canonical imaging function class or template 140. In embodiments, the canonical imaging function template 140 is embodied in computer-readable code, such as, for example, source code, a high-level programming language like C++, or other suitable computer-readable code or programming language. The canonical imaging function template 140 defines a template or class that includes a set of standard parts from which a canonical imaging function may be constructed. By designing each imaging function using canonical imaging functions, sets of functions can be easily combined together into optimized composite functions since the common sections of the canonical functions can be factored out of the combinatorial process of creating the composite function, leaving the unique processing elements of each canonical function to be composed together into a single composite function. In this manner, the common elements of each function are shared once in the outer loop, the function preamble, or the function post-amble. The function preamble is a portion of the beginning of the function, while the function post-amble is a portion of the end of the function. Both portions may be used to set-up or coordinate data processing. Further, the unique elements of each canonical function, such as the processing and algorithmic elements, are preserved in the composite function as shown in FIG. 2. More particularly, in embodiments, the canonical imaging function template 140 includes parameter checker 142, memory allocator 144, loop dimensions 146, outer loop 148, data read optimizer 150, compute 152, data write optimizer 154, memory de-allocator 156 and status reporter 160.

The current embodiments shown herein do not reflect all the methods of this invention. For example, embodiments may define additional application specific canonical sections according to the needs of the problem being solved. For example, an image read section, an image color correct section, an image color conversion section, an image geometric correct section, and the like may be included within the canonical imaging function. The canonical imaging functions may be extended to other problem domains as needed, and is especially amenable to the object-oriented programming methods of the C++ and JAVA programming languages which enable the canonical imaging function template to be used as a base class which may then be extended to include additional specific canonical sections.

The parameter checker 142 of the template 140 is configured to hold or coalesce code that, when executed, will check parameters which may be read or written, or parameters which otherwise receive input or output data used by a coalesced canonical imaging function. Similarly, the memory allocator 144 of the template 140 is configured to hold or coalesce code that, when executed, allocates memory that may be used to store the data used by a coalesced imaging function. The input data may include image data read from an input image data buffer or other computer-readable memory. The loop dimensions 146 is configured to hold or coalesce code that indicates the parameters or dimensions of the outer loop of a coalesced imaging function. In embodiments, the loop dimensions 146 may include code that indicates the number of pixels or regions of an image to be processed by the outer loop of a coalesced imaging function. The outer loop 148 is configured to hold or coalesce code that manages execution of a coalesced imaging function, such as, for example, by incrementing or otherwise maintaining counters and other outer loop control data. In embodiments, outer loop 148 keeps track of the location within an image (e.g., which pixel or region) is being processed or is next to be processed. The data read optimizer 150 is configured to hold or coalesce code that, when executed, performs the caching and look-ahead buffering of image data to be read, operated upon, or processed by the outer loop 148 of a coalesced imaging function. The compute 152 is configured to hold or coalesce code that, when executed, performs one or more computations, processing, or algorithmic elements on the image data. The data write optimizer 154 is configured to hold or coalesce code that, when executed, optimizes the process of writing data resulting from the operation of a coalesced imaging function. The memory de-allocator 156 is configured to hold or coalesce code that, when executed, frees or otherwise clears the memory previously allocated to the coalesced imaging function so that such memory may be available for use by other functions or for other purposes. The status reporter 160 is configured to hold or coalesce code that, when executed, provides status or other information related to the execution of the coalesced imaging function.

The canonical imaging function template 140 is a class from which an individual or a set of canonical imaging functions may be constructed. The individual canonical imaging functions so constructed are therefore instances of the canonical imaging function class. Thus, instances of the canonical imaging function class may be executed separately, much like monolithic functions, or may be combined together into a coalesced imaging function as is more particularly described hereinafter.

FIG. 2 illustrates an exemplary coalesced imaging function 200 formed by combining the exemplary canonical imaging functions 210A, 210B and 210C, each of which are instances of the canonical imaging function class 140. More particularly, coalesced function 200 is formed in part by coalescing the parameter checkers 212A-C of functions 210A-C into coalesced function 200. Similarly, coalesced function 200 is further formed, in part, by coalescing the memory allocators 214A-C of functions 210A-C into coalesced function 200. Loop dimensions 216A-C of functions 210A-C are also coalesced into coalesced function 200 as loop dimensions parent 236. Outer loops 218A-C of functions 210A-C are also coalesced into coalesced function 200 to form outer loop parent 238. Outer loop parent 238 includes data read optimizer parent 240, which combines into coalesced function 200 the data read optimizers 220A-C and the compute operations 222A-C of functions 210A-C. Outer loop parent routine 238 also includes data write optimizer parent 244, which combines data write optimizers 224A-C of functions 210A-C into coalesced function 200. Coalesced function 200 further includes the memory de-allocators 226A-C and status reporters 230A-C of functions 210A-C. Thus, in the depicted embodiment, three exemplary canonical functions are combined into one exemplary coalesced function 200.

When each of exemplary functions 210A-C are coalesced as described herein into coalesced function 200, a substantial gain in efficiency and/or performance may be achieved relative to the efficiency and/or performance of the corresponding individual (non-coalesced) monolithic functions. More particularly, the efficiency and/or increase in performance that is achieved by coalesced function 200 arises at least in part from the outer loop parent 238 being traversed only once, whereas, in contrast, the respective outer loops of the separate functions must each be traversed, including the respective data read and data write operations of each function. Thus, the need to redundantly access and/or pass data between functions is substantially reduced by utilizing coalesced function 200.

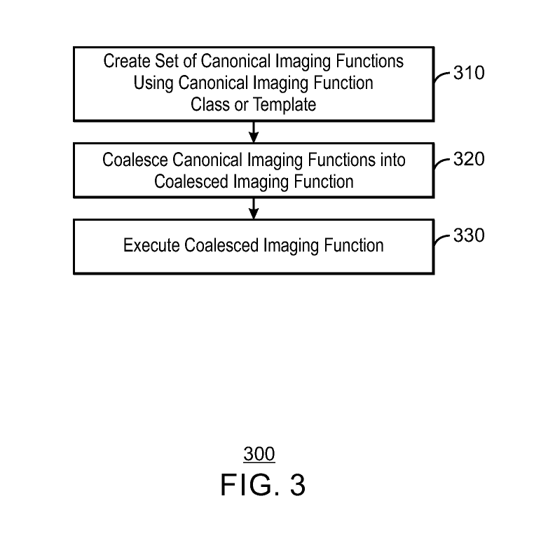

FIG. 3 is a process flow diagram for a method of coalescing canonical imaging functions 300 in accordance with embodiments. At block 310, a set of canonical imaging functions is created. In embodiments, canonical imaging function class or template 140 may be used to construct the set of canonical imaging functions, much as described above in regard to FIG. 2.

At block 320, a desired set or subset of the canonical imaging functions created at block 310 is coalesced to thereby form a coalesced imaging function, which, in embodiments, is much as described above in regard to coalesced imaging function 200. It should be noted that the process of coalescing a set of canonical imaging functions together into a coalesced imaging function may, in embodiments, be performed automatically by, for example, a function composer, without the need for manual intervention by a programmer or other person. In embodiments, the coalescing at block 320 may be performed using a compiler to determine which of the various attributes of the canonical imaging functions should be coalesced together during compilation of the coalesced imaging function. In this example, the compiler may infer which attributes of a given set of canonical imaging functions correspond to each other and should therefore be coalesced together. Moreover, in embodiments, a programmer may specify the attributes of the canonical imaging functions that are to be coalesced together.

In embodiments, an augmented reality library may be written utilizing the canonical imaging template or class 140 to create one or more coalesced imaging functions to create optimized imaging pipelines having substantially increased efficiency and performance relative to a corresponding library of monolithic imaging functions, such as the monolithic functions contained in conventional libraries, such as the Visual Compute Accelerator (VCA) library or Intel's Integrated Performance Primitives (IPP) library. Such a library of coalesced imaging functions may be utilized in various imaging applications, including computer vision, print and/or camera imaging, and graphics processing.

Moreover, in embodiments, the techniques described herein can be used to compile or translate the code into coalesced and canonical imaging functions. Specifically, the canonical imaging function templates enable a compiler or translator to assemble the combined canonical imaging function and generate new code to handle the data pre-fetches, reads, or writes according to the imaging functions. In embodiments, the code may be a high level language where a programmer may combine the canonical imaging functions into the high level code. Additionally, in embodiments, the code may be an intermediate level code wherein a compiler automatically coalesces the imaging functions into code as it is compiled. The compiler may use the canonical imaging function template to automatically coalesce the imaging functions. Further, in embodiments, the code may be an assembly level or native code wherein the imaging functions are coalesced into the assembly level or native code at runtime. Although the present techniques are described using imaging functions, and type of function may be used to generate canonical functions.

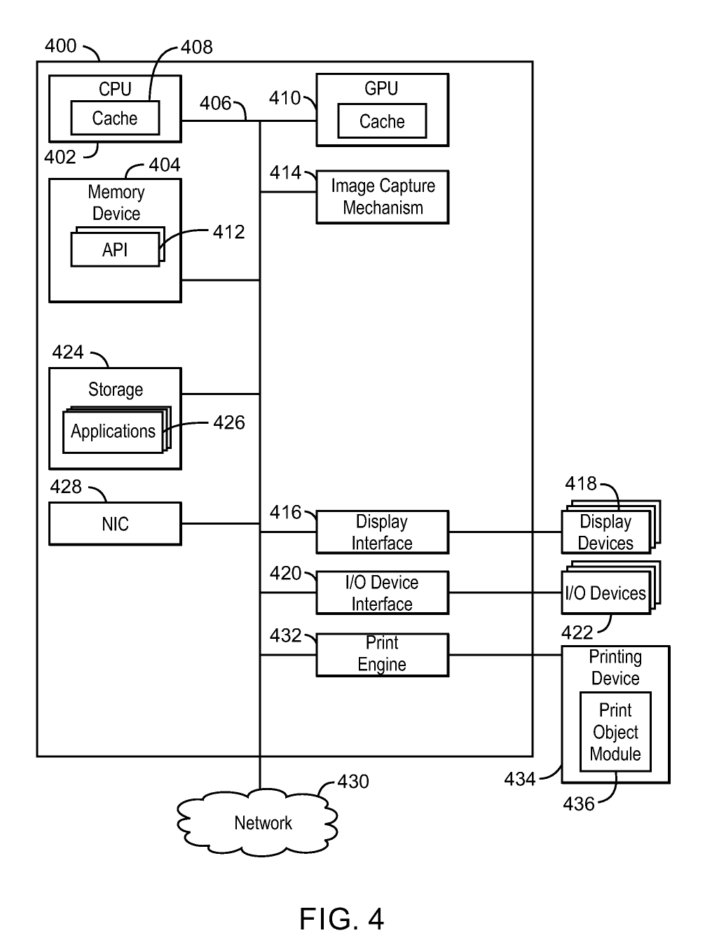

FIG. 4 is a block diagram of a computing device 400 that may be used in accordance with embodiments. The computing device 400 may be, for example, a laptop computer, desktop computer, tablet computer, mobile device, or server, among others. The computing device 400 may include a central processing unit (CPU) 402 that is configured to execute stored instructions, as well as a memory device 404 that stores instructions that are executable by the CPU 402. The CPU may be coupled to the memory device 404 by a bus 406. The CPU also includes a cache 408. In embodiments, the automatic pipeline composition may be optimized according to the size of the CPU cache 408. Additionally, the CPU 402 can be a single core processor, a multi-core processor, a computing cluster, or any number of other configurations. Furthermore, the computing device 400 may include more than one CPU 402. The instructions that are executed by the CPU 402 may be used to enable an automatic pipeline composition as described herein.

The computing device 400 may also include a graphics processing unit (GPU) 408. As shown, the CPU 402 may be coupled through the bus 406 to the GPU 408. The GPU 408 may be configured to perform any number of graphics operations within the computing device 400. For example, the GPU 408 may be configured to render or manipulate graphics images, graphics frames, videos, or the like, to be displayed to a user of the computing device 400. In some embodiments, the GPU 408 includes a number of graphics engines (not shown), wherein each graphics engine is configured to perform specific graphics tasks, or to execute specific types of workloads. The GPU also includes a cache 410. In embodiments, the automatic pipeline composition may be optimized according to the size of the CPU cache 410.

The memory device 404 can include random access memory (RAM), read only memory (ROM), flash memory, or any other suitable memory systems. For example, the memory device 404 may include dynamic random access memory (DRAM). The memory device 404 may include application programming interfaces (APIs) 412 that are configured to enable a user to construct a canonical imaging template or class, and to further construct a set of canonical imaging functions using the canonical imaging class, in accordance with embodiments.

The computing device 400 includes an image capture mechanism 414. In embodiments, the image capture mechanism 414 is a camera, stereoscopic camera, infrared sensor, or the like. The image capture mechanism 414 is used to capture image information to be processed. Accordingly, the computing device 400 may also include one or more sensors.

The CPU 402 may be connected through the bus 406 to an input/output (I/O) device interface 416 configured to connect the computing device 400 to one or more I/O devices 418. The I/O devices 418 may include, for example, a keyboard and a pointing device, wherein the pointing device may include a touchpad or a touchscreen, among others. The I/O devices 418 may be built-in components of the computing device 400, or may be devices that are externally connected to the computing device 400.

The CPU 402 may also be linked through the bus 406 to a display interface 420 configured to connect the computing device 400 to a display device 422. The display device 422 may include a display screen that is a built-in component of the computing device 400. The display device 422 may also include a computer monitor, television, or projector, among others, that is externally connected to the computing device 400.

The computing device also includes a storage device 424. The storage device 424 is a physical memory such as a hard drive, an optical drive, a thumbdrive, an array of drives, or any combinations thereof. The storage device 424 may also include remote storage drives. The storage device 424 includes any number of applications 426 that are configured to run on the computing device 400. The applications 426 may be used to combine the media and graphics, including 3D stereo camera images and 3D graphics for stereo displays. In examples, an application 426 may be used to construct a set of canonical imaging functions using the canonical imaging template or class, such as canonical imaging template 140, and to construct a coalesced imaging function, such as coalesced imaging function 200, in accordance with embodiments.

The computing device 400 may also include a network interface controller (NIC) 428 may be configured to connect the computing device 400 through the bus 406 to a network 430. The network 430 may be a wide area network (WAN), local area network (LAN), or the Internet, among others.

In some embodiments, an application 426 can process image data and send the processed data to a print engine 432. The print engine 432 may process the image data and the send the image data to a printing device 434. The printing device 434 can include printers, fax machines, and other printing devices that can print the image data using a print object module 436. In embodiments, the print engine 432 may send data to the printing device 434 across the network 430.

The block diagram of FIG. 4 is not intended to indicate that the computing device 400 is to include all of the components shown in FIG. 4. Further, the computing device 400 may include any number of additional components not shown in FIG. 4, depending on the details of the specific implementation.

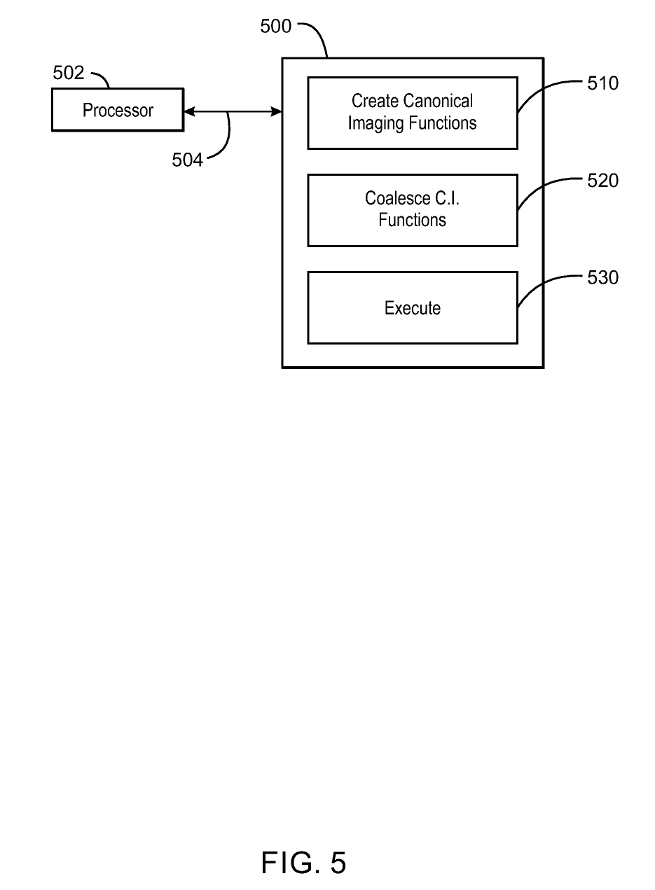

FIG. 5 is a block diagram showing tangible, non-transitory computer-readable media 500 that stores code for automatically creating a set of canonical imaging functions using the canonical imaging template or class, such as canonical imaging template 140, and to construct a coalesced imaging function, such as coalesced imaging function 200, in accordance with embodiments. The tangible, non-transitory computer-readable media 500 may be accessed by a processor 502 over a computer bus 504. Furthermore, the tangible, non-transitory computer-readable media 500 may include code configured to direct the processor 502 to perform the methods described herein, including method 300.

The various software components discussed herein may be stored on the tangible, non-transitory computer-readable media 500, as indicated in FIG. 5. For example, a module 510 may be configured to create a set of canonical imaging functions using canonical imaging class or template 140. A module 520 may be configured to automatically coalesce the set, or a subset of the set, of canonical imaging functions created by module 510 into a coalesced imaging function, such as coalesced imaging function 200. A module 530 may be configured to execute the coalesced imaging function.

The block diagram of FIG. 5 is not intended to indicate that the tangible, non-transitory computer-readable media 500 is to include all of the components shown in FIG. 5. Further, the tangible, non-transitory computer-readable media 500 may include any number of additional components not shown in FIG. 5, depending on the details of the specific implementation.

The following example shows a C++ implementation of a canonical imaging class or template implemented as a set of virtual functions instead of a single monolithic function, which permits each function to be picked apart and coalesced into a coalesced imaging function.

```
//
// Canonical Functions are implemented in this class as a set of virtual
functions
// instead of as a single monolithic function.
// This method allows each function to be picked apart and coalesced into
composite functions
//
class CanonicalFunction
{
  inline virtual void parameterChecker(parameterList_t parameters);
  inline virtual void memoryAllocator(parameterList_t, parameters);
  inline virtual void loopDimensions(parameterList_t, parameters);
  inline virtual void outerLoop(parameterList_t, parameters);
  inline virtual void dataReadOptimizer(parameterList_t parameters);
  inline virtual void compute(parameterList_t parameters);
  inline virtual void dataWriteOptimizer(parameterList_t parameters);
  inline virtual void memoryDeallocator(parameterList_t parameters);
  //
  // The function statusReporter( ) is a list or array of status codes
  // All functions may add their status code to the list
  //
  inline virtual void statusReporter(parameterList_t parameters);
}
class CanonicalFunction ComposedFunction
{
  //
  // This is where the composed function is created from other function
  //
};
class Composer
{
  ComposedFunction composedFunction;
  //
  // This function generates the coalesced code from a list of Canonical
Functions
  //
  void generateCode(void *code);
  //
  // The composer generates the code from a list of CanonicalFunction 's
  // Assumptions: Parent function is functionList[0] which defines the
outer loop dimensions
  //
  Composer(CanonicalFunction *functionList)
  {
    enum { PARENT_FUNCTION = 0};
    for (int x = 1; functionList[x] != 0; x++)
    {
      generateCode(functionList[x]->parameterChecker( ));
      generateCode(functionList[x]->memoryAllocator( ));
    }
    // Parent function
    generateCode(functionList[PARENT_FUNCTION]->loopRange( ));
    generateCode(functionList[PARENT_FUNCTION]->outerLoop( ));
    generateCode(functionList[PARENT_FUNCTION]->
    dataReadOptimizer( ));
    for (int x = 0; functionList[x] != 0; x++)
    {
      generateCode(functionList[x]->compute( ));
    }
    // Parent function
    generateCode(functionList[PARENT_FUNCTION]->
    dataWriteOptimizer( ));
    for (int x = 0; functionList[x] != 0; x++)
    {
      generateCode(functionList[x]->memoryDeallocator( ));
      generateCode(functionList[x]->statusReporter( ));
    }
  }
};
```

The following example shows an implementation of a set of three canonical imaging functions (CONVOLUTION, MEDIAN_FILTER, and COLOR_FILTER) utilizing the canonical imaging class or template 140.

```
class CanonicalFunction CONVOLUTION
{
  inline void parameterChecker(parameterList_t parameters){
  /* . . . code */ }
  inline void memoryAllocator(parameterList_t, parameters){
  /* . . . code */ }
  inline void loopDimensions(parameterList_t, parameters){
  /* . . . code */ }
  inline void outerLoop(parameterList_t, parameters) {
  /* . . . code */ }
  inline void dataReadOptimizer(parameterList_t parameters) {
  /* . . . code */ }
  inline void compute(parameterList_t parameters) {
  /* . . . code */ }
  inline void dataWriteOptimizer(parameterList_t parameters) {
  /* . . . code */ }
  inline void memoryDeallocator(parameterList_t parameters) {
  /* . . . code */ }
  inline void statusReporter(parameterList_t parameters) {
  /* . . . code */ }
}
Class Canonical Function MEDIAN_FILTER
{
  . . .
}
Class Canonical Function COLOR_FILTER
{
  . . .
}
```

### Example 1

An apparatus for generating canonical imaging functions is described herein. The apparatus includes logic to provide a canonical imaging function template and logic to form a set of canonical imaging functions from one or more monolithic imaging functions, each of said canonical imaging functions adhering to the canonical imaging function template. The apparatus also includes logic to coalesce one or more of the canonical imaging functions of the set of canonical imaging functions into a coalesced imaging function.

Each canonical imaging function may be defined as one or more sections of a complete function, where each function section is combined together to create a complete function. Additionally, each canonical imaging function of the set of canonical imaging functions may be combined together into a group as a set of shared and unique sections. Forming a set of canonical imaging functions may include logic to automatically compile the set of canonical imaging functions together into a single composed function using the canonical imaging function template. Further, coalescing the one or more canonical imaging functions into a single composed function may include logic to automatically compile or translate the coalesced imaging functions into new code which may be executed or further translated or compiled in another high level or intermediate language, or assembled into machine code for a target machine. The canonical imaging function template may include a beginning function section containing function preamble from a set of composed canonical functions, a common loop section configured to include a data read, compute, and data write operation sections from a set of canonical imaging functions, and an ending function section contain function post-amble from the set of canonical function sections. Additionally, the canonical imaging function template may further include at least one of a parameter checker section, a memory allocator section, a loop dimension section, a memory deallocator section, a status reporter section, other functional sections defined in the set of canonical functions, or any combination thereof. Coalescing a plurality of the canonical imaging functions may include combining one or more of the canonical imaging functions of the set of canonical imaging functions by utilizing the canonical imaging template. The apparatus may be a printing device or an image capture mechanism.

### Example 2

A system for generating canonical imaging functions is described herein. The system includes a processor, and the processor executes code that comprises imaging functions. The system also includes a set of canonical imaging functions formed from one or more monolithic imaging functions, each of said canonical imaging functions adhering to a canonical imaging function template. One or more of the canonical imaging functions of the set of canonical imaging functions is coalesced into an imaging function.

Each canonical imaging function may be defined as one or more sections of a complete function, where each function section is combined together to create a complete function. Each canonical imaging function of the set of canonical imaging functions may also be combined together into a group as a set of shared and unique sections. A set of canonical imaging functions may be formed by automatically compile the set of canonical imaging functions together into a single composed function using the canonical imaging function template. Further, coalescing the one or more canonical imaging functions into a single composed function may include automatically compiling or translating the coalesced imaging functions into new code which may be executed or further translated or compiled in another high level or intermediate language, or assembled into machine code for a target machine. The canonical imaging function template may include a beginning function section containing function preamble from a set of composed canonical functions, a common loop section configured to include a data read, compute, and data write operation sections from a set of canonical imaging functions, and an ending function section contain function post-amble from the set of canonical function sections. Additionally, the canonical imaging function template may further include at least one of a parameter checker section, a memory allocator section, a loop dimension section, a memory deallocator section, a status reporter section, other functional sections defined in the set of canonical functions, or any combination thereof. Coalescing a plurality of the canonical imaging functions may include combining one or more of the canonical imaging functions of the set of canonical imaging functions by utilizing the canonical imaging template.

### Example 3

At least one non-transitory machine readable medium is described herein. The non-transitory machine readable medium has instructions stored therein that, in response to being executed on a device, cause the device to form a set of canonical imaging functions from a plurality of monolithic imaging functions, each of said canonical imaging functions adhering to a canonical imaging function template, and coalesce one or more of the canonical imaging functions of the set of canonical imaging functions into a coalesced imaging function.

The non-transitory machine readable medium may further include instructions that, when executed on a device, may cause the device to place a data read, compute, and data write operations of the canonical imaging functions into an outer loop of the coalesced imaging function. Additionally, the non-transitory machine readable medium may further include instructions that, when executed on a device, cause the device to execute the coalesced imaging function.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. An apparatus for generating canonical imaging functions, comprising:
logic to provide a canonical imaging function template;
logic to form a set of canonical imaging functions from one or more monolithic imaging functions, each of said canonical imaging functions adhering to the canonical imaging function template; and
logic to coalesce one or more of the canonical imaging functions of the set of canonical imaging functions into a coalesced imaging function.

2. The apparatus of claim 1, wherein each canonical imaging function is defined as one or more sections of a complete function, where each function section is combined together to create a complete function.

3. The apparatus of claim 2, wherein each canonical imaging function of the set of canonical imaging functions is combined together into a group as a set of shared and unique sections.

4. The apparatus of claim 1, wherein forming a set of canonical imaging functions comprises logic to automatically compile the set of canonical imaging functions together into a single composed function using the canonical imaging function template.

5. The apparatus of claim 1, wherein coalescing the one or more canonical imaging functions into a single composed function comprises logic to automatically compile or translate the coalesced imaging functions into new code which may be executed or further translated or compiled in another high level or intermediate language, or assembled into machine code for a target machine.

6. The apparatus of claim 1, wherein the canonical imaging function template comprises a beginning function section containing function preamble from a set of composed canonical functions, a common loop section configured to include a data read, compute, and data write operation sections from a set of canonical imaging functions, and an ending function section contain function post-amble from the set of canonical function sections.

7. The apparatus of claim 6, wherein the canonical imaging function template further comprises at least one of a parameter checker section, a memory allocator section, a loop dimension section, a memory deallocator section, a status reporter section, other functional sections defined in the set of canonical functions, or any combination thereof.

8. The apparatus of claim 1, wherein coalescing a plurality of the canonical imaging functions comprises combining one or more of the canonical imaging functions of the set of canonical imaging functions by utilizing the canonical imaging template.

9. The apparatus of claim 1, wherein the apparatus is a printing device.

10. The apparatus of claim 1, wherein the apparatus is an image capture mechanism.

11. A system for generating canonical imaging functions, wherein the system comprises:
a processor, wherein the processor executes code that comprises imaging functions;
a set of canonical imaging functions formed from one or more monolithic imaging functions, each of said canonical imaging functions adhering to a canonical imaging function template, wherein one or more of the canonical imaging functions of the set of canonical imaging functions are coalesced into an imaging function.

12. The system of claim 11, wherein each canonical imaging function is defined as one or more sections of a complete function, where each function section is combined together to create a complete function.

13. The system of claim 11, wherein each canonical imaging function of the set of canonical imaging functions is combined together into a group as a set of shared and unique sections.

14. The system of claim 11, wherein forming a set of canonical imaging functions comprises logic to automatically compile the set of canonical imaging functions together into a single composed function using the canonical imaging function template.

15. The system of claim 11, wherein coalescing the one or more canonical imaging functions into a single composed function comprises automatically compiling or translating the coalesced imaging functions into new code which may be executed or further translated or compiled in another high level or intermediate language, or assembled into machine code for a target machine.

16. The system of claim 11, wherein the canonical imaging function template comprises a beginning function section containing function preamble from a set of composed canonical functions, a common loop section configured to include a data read, compute, and data write operation sections from a set of canonical imaging functions, and an ending function section contain function post-amble from the set of canonical function sections.

17. The system of claim 16, wherein the canonical imaging function template further comprises at least one of a parameter checker section, a memory allocator section, a loop dimension section, a memory deallocator section, a status reporter section, other functional sections defined in the set of canonical functions, or any combination thereof.

18. The system of claim 11, wherein coalescing a plurality of the canonical imaging functions comprises combining one or more of the canonical imaging functions of the set of canonical imaging functions by utilizing the canonical imaging template.

19. At least one non-transitory machine readable medium having instructions stored therein that, in response to being executed on a device, cause the device to:
form a set of canonical imaging functions from a plurality of monolithic imaging functions, each of said canonical imaging functions adhering to a canonical imaging function template; and
coalesce one or more of the canonical imaging functions of the set of canonical imaging functions into a coalesced imaging function.

20. The non-transitory machine readable medium having instructions stored therein of claim 19, further comprising instructions that, when executed on a device, cause the device to place a data read, compute, and data write operations of the canonical imaging functions into an outer loop of the coalesced imaging function.

21. The non-transitory machine readable medium having instructions stored therein of claim 19, further comprising instructions that, when executed on a device, cause the device to execute the coalesced imaging function.
